(19) United States
(12) Patent Application Publication
(10) Pub. No.: US 2016/0062508 A1
(43) Pub. Date: Mar. 3, 2016

(54) Dynamic Drawers

(71) Applicant: MULTITOUCH OY, Helsinki (FI)

(72) Inventor: Tommi ILMONEN, Espoo (FI)

(73) Assignee: MULTITOUCH OY, Helsinki (FI)

(21) Appl. No.: 14/781,095

(22) PCT Filed: Apr. 30, 2013
(86) PCT No.: PCT/FI2013/050480

§ 371 Date: Sep. 29, 2015

(51) Int. Cl. G06F 3/044; G06F 3/0488; G06F 3/0484; G06F 3/041; G06F 3/0481

(52) U.S. Cl. CPC G06F 3/044; G06F 3/0412; G06F 3/04817; G06F 3/04842; G06F 3/04883; G06F 3/04886; G06F 2203/04108

(57) ABSTRACT

An apparatus comprising a display and a processor configured to cause displaying a first set of display objects and a second set of display objects in such a way that user input activating a display object of the first set of display objects causes the second set of display objects to be revealed on the display. The second set of display objects is revealed in a direction corresponding to the user input and in synchronization with the user input.

### TECHNICAL FIELD

The present invention generally relates to control of electronic devices. The invention relates particularly, though not exclusively, to control of electronic devices using a touch sensitive display.

### BACKGROUND ART

Electronic devices such as televisions, computers, smart phones and tablet computers are controlled by a user interface. As the complexity and number of the functionalities offered increases, there is a need for simplifying the user interface and improving the user experience by providing intuitive control functions.

Electronic devices are often controlled using a user interface on a display and the control functions are carried out by manipulating display objects, e.g. by using a pointer device or touch of the user. A touch sensitive display provides an intuitive user interface by using gestures of the user on the touch sensitive display for manipulating the display objects.

Display objects, i.e. virtual objects such as buttons, icons, menu items or sliders, shown on the display require display space. Hence, the number of display objects shown, the grouping thereof and the functionalities in manipulating the objects need to be flexible.

In prior art solutions, the display objects are often grouped into menus or windows from which diverse functionalities are activated. Such menus, for example pull down menus, tabs or menu palettes, occupy space, clutter the user interface, and in that way disturb the use of the applications or programs being run on the electronic device, especially as less important display objects are often displayed with important ones. In some prior art solutions, the structure of the menus can be changed through tedious configuration.

It is an object of the invention to avoid or mitigate problems relating to accessibility to various functions without undue cluttering, or to at least provide a new technical alternative to existing ones.

### SUMMARY

According to a first example aspect of the invention there is provided an apparatus comprising
a display; and
a processor;
wherein
the processor is configured to:
   cause displaying a first set of display objects; and
   cause displaying a second set of display objects in such a way that user input activating a display object of the first set of display objects causes the second set of display objects to be revealed on the display; wherein
   the second set of display objects is revealed in a direction corresponding to the user input and in synchronization with the user input.

The processor may further be configured to cause displaying a further set of display objects in such a way that user input activating a display object of a set of display objects causes the further set of display objects to be revealed on the display; wherein the further set of display objects is revealed in a direction corresponding to the input and in synchronization with the input.

The processor may further be configured to cause rearranging the display objects of a set of display objects in response to user input.

The processor may further be configured to cause hiding a set of display objects in response to user input.

The display may be a touch sensitive display.

The user input may comprise gestures on or above the touch sensitive display.

The user input may comprise a sliding gesture on or above the touch sensitive display.

The processor may further be configured to cause displaying the first set of display objects in response to user input.

According to a second example aspect of the invention there is provided a method comprising:
displaying a first set of display objects on a display; and
displaying a second set of display objects in such a way that user input activating a display object of the first set of display objects causes the second set of display objects to be revealed on the display; wherein
the second set of display objects is revealed in a direction corresponding to the user input and in synchronization with the user input.

The method may further comprise
displaying a further set of display objects in such a way that user input activating a display object of a set of display objects causes the further set of display objects to be revealed on the display; wherein
the further set of display objects is revealed in a direction corresponding to the input and in synchronization with the input.

The method may further comprise rearranging the display objects of a set of display objects in response to user input.

The method may further comprise hiding a set of display objects in response to user input.

The display objects may be displayed on a touch sensitive display.

The user input may comprise gestures on or above the touch sensitive display.

The user input may comprise a sliding gesture on or above the touch sensitive display.

The method may further comprise displaying the first set of display objects in response to user input.

According to a third example aspect of the invention there is provided a program product comprising computer code for causing performing the method of the second example aspect, when executed by an apparatus

According to a fourth example aspect of the invention there is provided a memory medium comprising the computer program of the third example aspect.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be understood that corresponding embodiments may apply to other example aspects as well.

### BRIEF DESCRIPTION OF THE DRAWINGS

Some example embodiments of the invention will be described with reference to the accompanying drawings, in which:

FIG. 1 shows a schematic view of an apparatus according to an example embodiment of the invention;

FIG. 2 shows a schematic view of an apparatus according to an example embodiment;

FIGS. 3a-3c show schematically a sequence of operations of a dynamic drawer structure according to an example embodiment of the invention;

FIGS. 4a-4f show schematically a sequence of operations of a dynamic drawer structure according to an example embodiment of the invention;

FIGS. 5a-5c show schematically a sequence of operations of a dynamic drawer structure according to an example embodiment of the invention;

FIGS. 6a-6c show schematically a sequence of operations of a dynamic drawer structure according to an example embodiment of the invention;

FIGS. 7a-7c show schematically a sequence of operations of a dynamic drawer structure according to an example embodiment of the invention; and

FIGS. 8a-8c show schematically a sequence of operations of a dynamic drawer structure according to an example embodiment of the invention; and

FIGS. 9a-9f show schematically a sequence of operations of a dynamic drawer structure according to an example embodiment of the invention; and

### DETAILED DESCRIPTION

In the following description, like reference signs denote like elements.

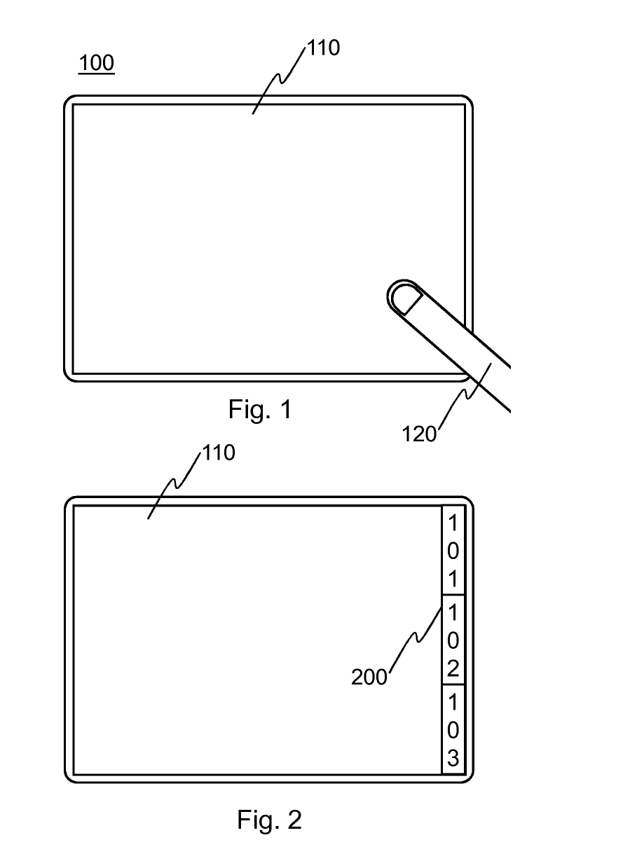

FIG. 1 shows a schematic view of an apparatus 100 according to an example embodiment of the invention. The apparatus is for example an electronic device with user interface, such as a computer, a television, a tablet computer, a smartphone, an e-book-reader or a media player. The apparatus 100 comprises a display 110 for displaying various types of content, for example media, and user interface elements, i.e. display objects. In FIG. 1, the apparatus 100 is controlled via a user interface, the elements of which are shown on the display 110.

A skilled person appreciates that the apparatus 100 comprises elements not shown in FIG. 1, such as a processor configured to provide and/or control the functionality of the apparatus 100, and a memory for storing data and software executable by the processor. In a further example embodiment, apparatus 100 comprises further elements (not shown), such as sensors or detectors, communication units, or further user interface elements such as a keyboard, hardware or software buttons, touch sensitive displays or surfaces, slider controls or switches. Furthermore, the apparatus comprises, in a further example embodiment, further elements (not shown), such as further user interface elements, microphones, speakers, sensors or detectors and/or camera units.

In an embodiment, the display 110 of FIG. 1 is a touch sensitive display. The touch sensitive display 110 comprises, for example, a touch sensor for detecting the touch and/or gestures of the user, e.g. with a finger 120 or a stylus, on or in proximity thereof. The touch sensor is implemented for example using any of a resistive, a surface acoustic wave, a capacitive such as a surface capacitance, a projected capacitance, a mutual capacitance, or self-capacitance an infrared, an optical, a dispersive signal and/or acoustic pulse recognition touch sensor or an array thereof. Alternatively, or in addition to the touch of the user, the display objects can be manipulated by a pointing device such as a mouse, a keyboard or a touchpad.

FIG. 2 shows a schematic view of the apparatus 100 and dynamic drawer structure according to an example embodiment of the invention. On the right-hand side of the display 110 a column 200 of display objects 101-103, i.e. a menu column, is shown. The displaying of the display objects is controlled, for example, by software stored in the memory and executed by the processor of the apparatus 100, i.e. the processor is configured to cause displaying of the display objects 101-103. In the present example, the column 200 is visible at all times while the display is turned on, and/or the processor is configured to cause the column 200 to appear in response to a predetermined input, such as gesture or touch, of the user. The column 200 is in another embodiment displayed at a different location, e.g. on the left-hand side of the display, or in the middle. In yet another embodiment, the display objects 101-103 are arranged in a row in addition to or instead of the column 200, or even scattered in several locations on the display as separate display objects. In an embodiment, user preferences on the appearance and displaying of the display objects are stored for subsequent use e.g. in the memory of the apparatus 100.

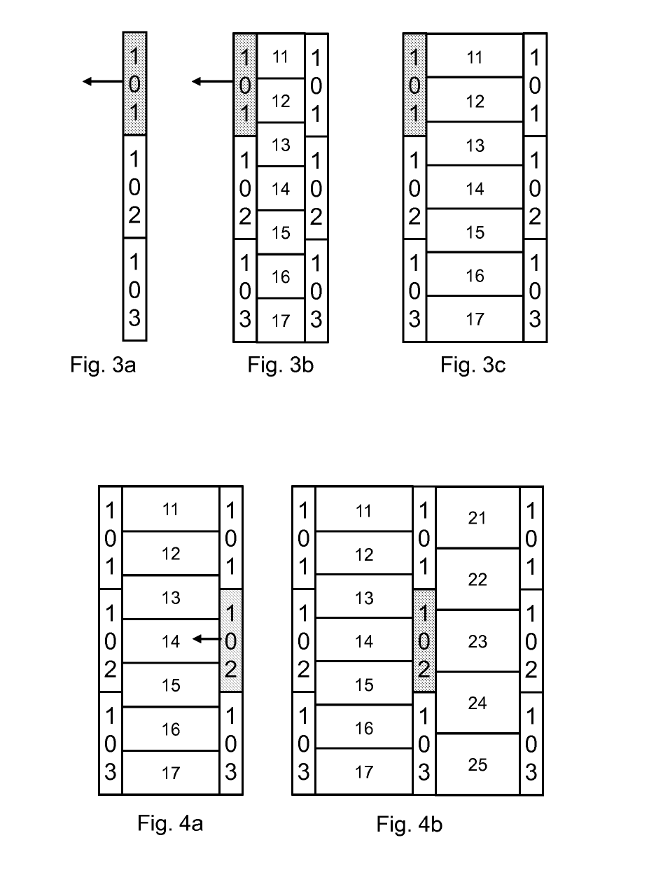

FIGS. 3a-3c show schematically a sequence of operations of a dynamic drawer structure according to an example embodiment of the invention. The processor of the apparatus 100 is configured to cause displaying the display objects and configured to control and carry out the operations described hereinafter with reference to FIGS. 3a-9f in response to user manipulation of the display objects, i.e. in response to user activating a display object by providing input for example by using a touch sensitive display. A skilled person understands that although FIGS. 3a-9f have been illustrated with a vertical menu column, a horizontal row or a still different configuration is alternatively used.

FIG. 3a shows display objects 101-103 arranged on a column. A user activates the display object 101, for example to open a list, set or a menu of further display objects 11-17. The user slides in FIGS. 3b-3c, e.g. by touch or with a mouse pointer, the display object 101. The sliding creates a further column of display objects 101-103, or alternatively a copy of the display object being activated, and this copy then slides to a new position. Alternatively, the original column is dragged to a new position. The further column is basically a copy of the first column and the display objects 11-17 are revealed in the space between the columns, or next to a single column, as the column slides further. The revealing of the display objects by sliding is akin to a drawer being opened, and it should be noted that the set of objects opened from a display object 101-103 is referred to as a drawer hereinafter and -before. The size to which the drawer is opened to depends for example on the length of the sliding gesture, or alternatively on the duration thereof.

Although a single direction of sliding movement and a single direction in which further display objects are revealed is shown in FIGS. 3a-9f, an opposite sliding movement, or a vertical or diagonal sliding movement as well as an arcuate sliding gesture, is envisaged as an alternative or in addition. A skilled person appreciates that in FIGS. 3a-9f instead of a sliding movement, the drawer is quickly opened to a predetermined size for example by clicking, tapping, or double-clicking, i.e. without the sliding movement in synchronization with which the set of display objects 11-17 is revealed.

Moreover, although the drawers are depicted as having a different numbers of display objects, each drawer reveals in an embodiment a similar number of display objects. Furthermore, instead of multiple display objects, only a single display object and/or for example a picture or a video is in the drawer and revealed.

Furthermore, reversing the sequences shown in FIGS. 3a-9f closes the drawers, i.e. the revealed display objects are hidden and the dynamic drawer structure returned to the previous configuration. A skilled person appreciates that in FIGS. 3a-9f instead of a sliding movement, the drawer is quickly closed for example by clicking, tapping, or double-clicking, i.e. without the sliding movement. Moreover, the sliding movement of the drawers is in some embodiments synchronized with further functionalities, e.g. with sound and/or sequence of images being played.

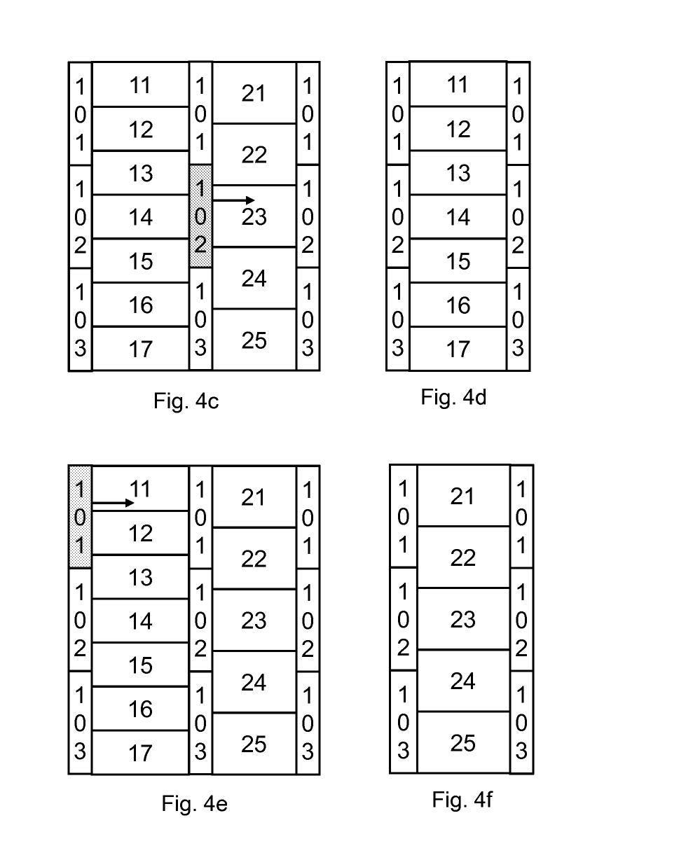

FIGS. 4a-4b show schematically a further sequence of operations starting from the situation of FIG. 3c according to an example embodiment of the invention. A user activates a further display object 102, for example to open a further list, set or a menu of further display objects 21-26. The user slides in FIGS. 6b-6c, e.g. by touch or with a mouse pointer, the display object 102 creating a copy thereof, or a copy of the whole column as hereinbefore described, and the display objects 21-26 are revealed, as were the display objects 11-17 previously, when the further drawer is opened. The previously opened drawer slides further to make space for the new drawer to be opened.

FIGS. 4c-4d show the sequence of FIGS. 4a-4b being reversed, as a user activates the display object 102, to close the drawer. The user slides, e.g. by touch or with a mouse pointer, the display object 102 in the direction of the original menu column to close the drawer and the display objects 21-26 are again hidden. FIGS. 4e-4f show a further sequence of operations according to an embodiment and starting from the situation of FIG. 4c. The user activates the display object 101 to close the drawer. The user slides, e.g. by touch or with a mouse pointer, the display object 101 in the direction of the original menu column to close the drawer and the display objects 11-17 are hidden

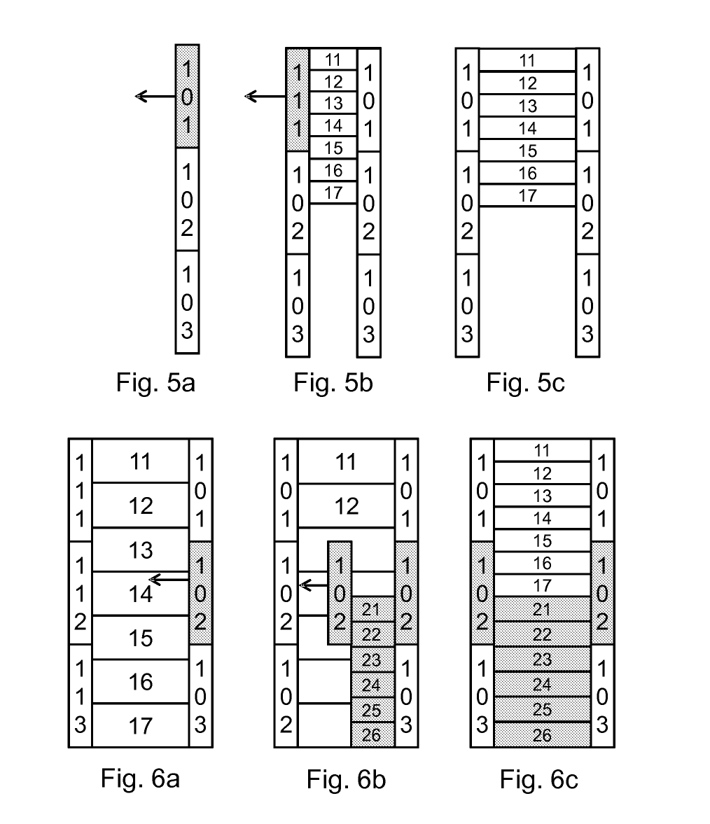

FIGS. 5a shows a further sequence of operations according to an embodiment of the invention. FIG. 5a again shows display objects 101-103 arranged on a column, as in FIG. 3a. A user activates the display object 101, for example to open a list, set or a menu of further display objects 11-17. The user slides in FIGS. 5b-5c, e.g. by touch or with a mouse pointer, the display object 101. The sliding creates a further column of display objects 101-103, or alternatively a copy of the display object being activated, and this copy then slides to a new position. Alternatively, the original column is dragged to a new position. The further column is basically a copy of the first column and the display objects 11-17 are revealed, as the column slides further. The revealed display objects 11-17 fill only a part of the space between the menu columns, for example depending on the number thereof or on a predetermined default size setting that is for example specified by the user.

FIGS. 6a-6c show schematically a further sequence of operations starting from the situation of FIG. 3c, or alternatively from that of FIG. 5c (not shown), according to an embodiment of the invention. A user activates a further display object 102, for example to open a further list, set or a menu of further display objects 21-26. The user slides, in FIGS. 6b-6c, e.g. by touch or with a mouse pointer, the display object 102 creating a copy thereof, or a copy of the whole column as hereinbefore described, and the display objects 21-26 are revealed as the further drawer is opened.

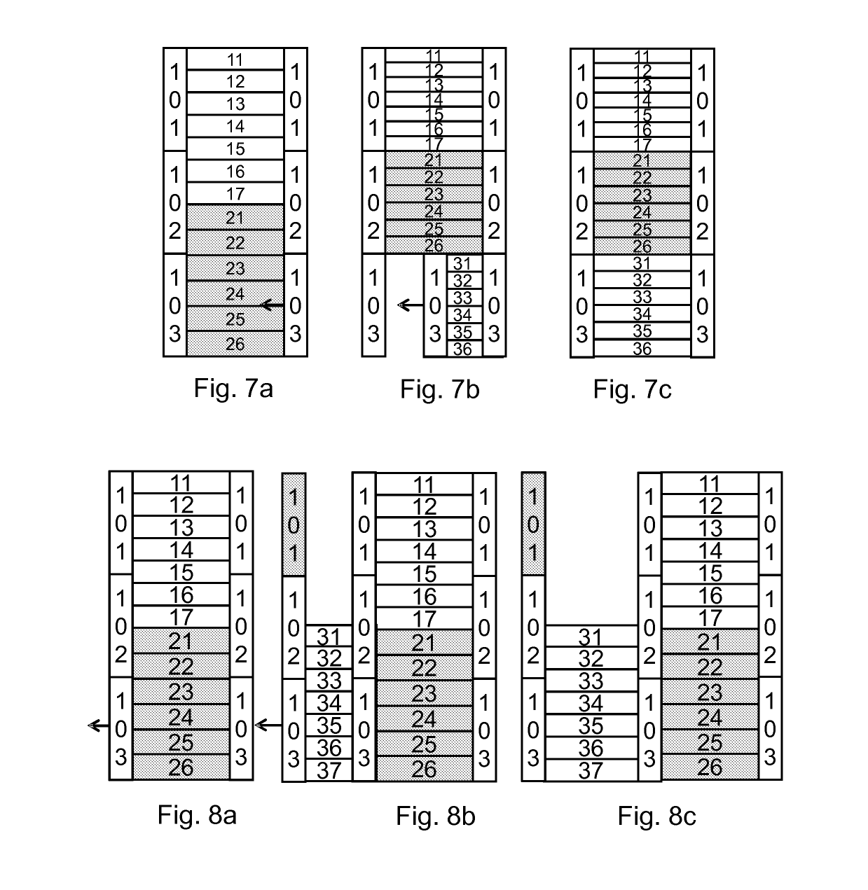

The display objects 21-26 occupy a space of the display in which no display objects were shown previously, if previously opened drawer does not occupy all of the space between the menu columns. If no space is available between the menu columns, the display objects 11-17 and/or 21-26 are made smaller and/or partially hidden, as is shown in FIGS. 6b-7c.

FIGS. 7a-7c show schematically a further sequence of operations starting from the situation of FIG. 6c according to an example embodiment of the invention. A user activates a further display object 103, for example to open a further list, set or a menu of further display objects 31-36. The sequence of operations in opening the further drawer is as hereinbefore described with reference to FIGS. 6a-6c.

FIGS. 8a-8c show schematically a further sequence of operations starting from the situation of FIG. 6c according to an embodiment of the invention. Alternatively, the sequence of FIGS. 8a-8c starts for example from the situation of FIG. 3c or 7a. A user activates a further display object 103, for example open a list, set or a menu of further display objects 31-37. The user slides, in FIGS. 8b-8c, e.g. by touch or with a mouse pointer, the display object 103 of a menu column in a direction opposite to the revealed display objects 11-17 and 21-26 creating a further column of display objects 101-103, or alternatively a copy of the display object being activated, or the original column is dragged to a new position. The further column is basically a copy of the first and second columns and the display objects 31-32 are revealed, at a new space between the columns, i.e. a new drawer is drawn out, as the column slides further. In a further embodiment, the display objects 31-37 occupy the whole space between the columns, as hereinbefore described with reference to FIGS. 3a-3c.

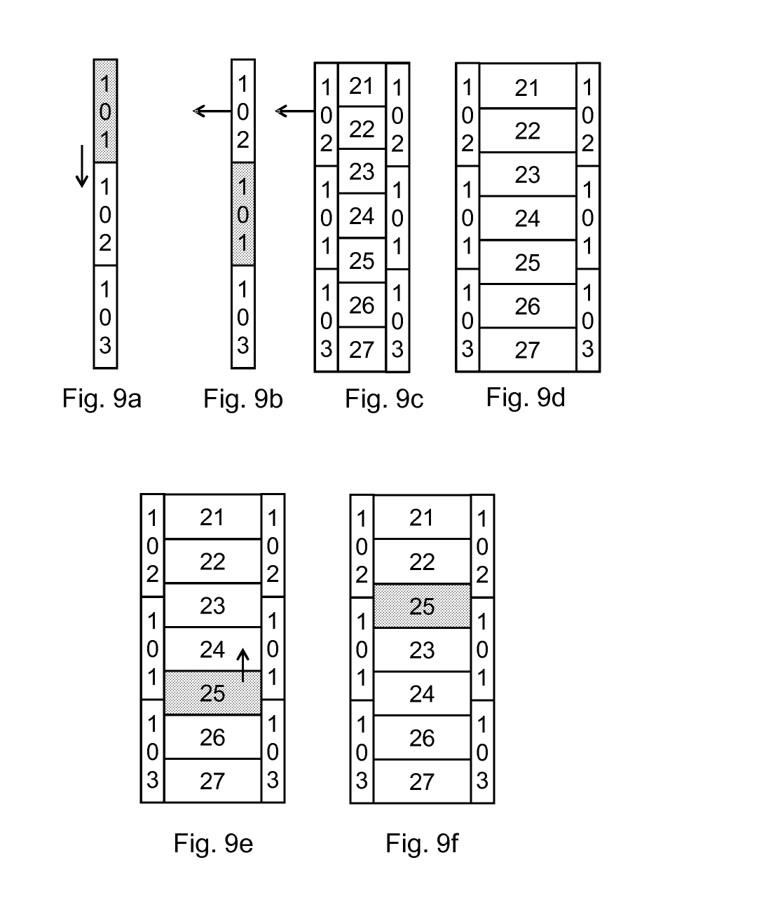

FIGS. 9a-9f show schematically a further sequence of operations according to an example embodiment of the invention. The user changes the order of, i.e. rearranges, the display objects 101-103, i.e. the order in which the drawers that are opened from the display objects 101-103 are stacked, for example as he wishes to have the display object 101 in the middle. The display object 101 is moved to a new position in the column by sliding. Subsequently, as the user slides, in FIGS. 9b-9c, e.g. by touch or with a mouse pointer, the display object 102 creating a further column of display objects 101-103, the sequence of operations corresponds to that described hereinbefore with reference to FIGS. 3a-3c, or alternatively to that of FIGS. 5a-5c, with the display objects 21-27 now opening from the top display object of the column, i.e. from the top of the menu column. In FIG. 9e, the user changes the order of the display objects 21-27 by sliding an object to be moved in the desired location in the drawer.

In a further embodiment, the display objects 21-27, or the display objects 11-17 or 31-37, are activated in a manner similar to the display objects 101-103 to open further drawers.

Furthermore, the sequence of operations, or a part thereof, of any example embodiment described hereinbefore can be combined to any other example embodiment described.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Various embodiments have been presented. It should be appreciated that in this document, words comprise, include and contain are each used as open-ended expressions with no intended exclusivity.

Furthermore, some of the features of the afore-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. An apparatus comprising
a display; and
a processor;
wherein
the processor is configured to:
cause displaying a first set of display objects; and
cause displaying a second set of display objects in such a way that user input activating a display object of the first set of display objects causes the second set of display objects to be revealed on the display; wherein
the second set of display objects is revealed in a direction corresponding to the user input and in synchronization with the user input.

2. The apparatus of claim 1, wherein the processor is further configured to cause displaying a further set of display objects in such a way that user input activating a display object of a set of display objects causes the further set of display objects to be revealed on the display; and wherein the further set of display objects is revealed in a direction corresponding to the input and in synchronization with the input.

3. The apparatus of claim 1, wherein the processor is further configured to cause rearranging the display objects of a set of display objects in response to user input.

4. The apparatus of claim 1, wherein the processor is further configured to cause hiding a set of display objects in response to user input.

5. The apparatus of claim 1, wherein the display is a touch sensitive display.

6. The apparatus of claim 5, wherein user input comprises gestures on or above the touch sensitive display.

7. The apparatus of claim 5, wherein user input comprises a sliding gesture on or above the touch sensitive display.

8. The apparatus of claim 1, wherein the processor is further configured to cause displaying the first set of display objects in response to user input.

9. A method comprising:
displaying a first set of display objects on a display; and
displaying a second set of display objects in such a way that user input activating a display object of the first set of display objects causes the second set of display objects to be revealed on the display; wherein
the second set of display objects is revealed in a direction corresponding to the user input and in synchronization with the user input.

10. The method of claim 9, further comprising
displaying a further set of display objects in such a way that user input activating a display object of a set of display objects causes the further set of display objects to be revealed on the display; wherein
the further set of display objects is revealed in a direction corresponding to the input and in synchronization with the input.

11. The method of claim 9, further comprising rearranging the display objects of a set of display objects in response to user input.

12. The method of claim 9, further comprising hiding a set of display objects in response to user input.

13. The method of claim 9, wherein the display objects are displayed on a touch sensitive display.

14. The method of claim 13, wherein user input comprises gestures on or above the touch sensitive display.

15. The method of claim 13, wherein user input comprises a sliding gesture on or above the touch sensitive display.

16. The method of claim 9 further comprising displaying the first set of display objects in response to user input.

17. A computer program product comprising computer code in non-transient form, the code for causing performing the method of claim 9, when executed by an apparatus.

18. A non-transient memory medium comprising the computer program of claim 17.
